(19) United States
(12) Patent Application Publication
(10) Pub. No.: US 2014/0282676 A1
(43) Pub. Date: Sep. 18, 2014

(54) INTERACTIVE INCENTIVE DRIVEN PARTICIPATORY SYSTEM AND METHOD FOR ENGAGING MULTIMEDIA AUDIENCE

(71) Applicant: Donald W. Joergens, Flemington, NJ (US)

(72) Inventor: Donald W. Joergens, Flemington, NJ (US)

(21) Appl. No.: 13/841,454

(22) Filed: Mar. 15, 2013

(51) Int. Cl. H04N 21/475; H04N 21/81

(52) U.S. Cl. CPC H04N 21/4758; H04N 21/812
USPC 725/23

(57) ABSTRACT

An interactive incentive driven participatory system provides incentives to viewers of an advertising commercial or promotional message. The system is used in conjunction with a device having capability to receive and transmit messages and accept input via a user interface. An interactive incentive website associated with software including entry of at least one advertising or promotional message, at least one query, and user information associated with a user of the machine is provided. The website displays the advertising or promotional message and the query to the user. The information of the website may also be displayed or audibly presented directly during a broadcast. At least one answer prompt is associated with the query adapted to prompt the user to respond. A central processing station receives, stores and assesses answers, and a central processor processes the user's answers into points/tickets correlating to incentives and market data.

### BACKGROUND OF THE INVENTION

1. Field of the Invention

The present invention relates to systems and methods for incentivizing viewers and listeners engagement and participation in advertising, advertisement messages, communications and content; and, more particularly, to the interactive systems and methods for enhancing advertisement and marketing mediums.

2. Description of the Prior Art

Advertising and marketing effectiveness is dependent upon consumers actually viewing or listening to advertisement messages. A significant portion of funding for most privately owned television networks is made-up of advertising revenue. Advertising spots range in length from brief advertising spots ranging from a few seconds to several minutes, up to program-length infomercials. Brief advertising spots make up the vast majority of television advertisements today, and are used to promote a wide variety of goods, services and ideas, as is the case since the dawn of television. Viewership of television programming, as one example medium, commonly measured by companies including Nielsen Media Research, is frequently used as a metric for determining television placement of advertisements, and the rates charged to advertisers to air within a given network, television program, or time of day (called a “daypart”).

New-media landscapes offer a plethora of impediments that render entertainers and entertainment companies struggling to pass the advertisement message to consumers. Due to advancing and omnipresent technology, including digital video recording (DVR) devices that allow for the viewing of television programs or movies while forwarding, skipping, jumping, etc., over the commercials, fewer viewers are actually watching advertisement messages. DVR systems, and other digital recording systems, quickly allow users to forward past or skip advertising media.

Economic losses have resulted for networks and their corporate advertising clients due in part to the lack of commercial message penetration by avoidance or apathetic non-engagement of the commercial/advertising event. In turn, these corporate and non-corporate advertising clients and entertainment companies seek to pay less for advertising slots that are considered less valuable because they are viewed less by consumers, thereby resulting in less selling influence. Even when taking DVRs out of the equation, additional decreased viewing occurs because many consumers mute ads or simply change the channel. Channel surfing away from a program during commercial breaks can be done quickly and readily with the hundreds of other channels to view while the commercials run.

With widespread, and gaining, use of DVRs in households, the impact of DVRs on advertising effectiveness has become problematic. Advertising potential and value has vastly been impacted through DVR and other digital playback technology.

Adjusting advertising strategies to increase viewership has become imminent in addressing the value loss problem advertisers and networks are facing. Such considerations in determining strategies include determining the target audience, its ethnicity, location, socio-demographics, age, gender, etc., along with factors like program genre and time of day. Adjustments in advertising strategy are then carried out based on these and other determinations. In further considering advertising strategies in light of DVR and other advertising skipping technology a tailored response encompassing issues such as spending levels, program selection, day-part selection, creative strategy, frequency, advertising format (commercials, product placement, sponsoring, etc.), positioning, and target audience selection, must be thought-out.

With the continued advent of new technologies and digital recording devices, advertisers and networks must seek systems and methods that embrace these technologies and reverse erosion of high-impact, high-reach advertising messages.

Various systems and methods have been employed in order to increase listening and viewership of advertising messages, including for example streaming advertisements on a television or digital screen as a banner during a television, radio, or video program. Effectiveness of such advertising is questionable as it is readily ignored, often seen as an annoying distraction and poor, forced attempt at gaining some fractional attention of the viewer. As these ad banners are streamed during program or video airing, these streaming ads only consist of visual features, and do not have audio components, consequently limiting its impression on the consumer. Other efforts have recently been sought to avoid advertising ad skipping employed-by entertainment companies and advertisers involve attempts to constrain digital recording technology itself targeting technology that hops over commercials during the recording event, or targeting technology that provides the ability to skip commercials during playback. These attempts have had limited success and are costly and are counter-intuitive to technological advancement.

There remains a need in the art for a system and method that addresses problems in the art concerning the airing and viewing of advertising media. Further, there exists a need in the art for a system and method that increases the likelihood of viewership of television and radio commercials to provide high-impact, deeper message penetration, audience participation and interaction while promoting a higher volume audience reaching of advertising methods. Lastly, there is a need in the art for a system and method that provides real-time incentives to viewers watching or listening to advertising messages. There further exists a need for a commercial/advertising message creating a relationship, even an expectant bond, between advertisers and consumers.

### SUMMARY OF THE INVENTION

The present invention is directed to an interactive incentive driven participatory system enhancing and engaging participant audiences involvement advertising system and method that prompts potential consumers of any given audience with queries, questions, messages, promotions, and/or quizzes during any multimedia advertising commercial(s) or promotional event to actively and/or interactively engage cognitively and/or physically the audience participant through the offering of a chance(s) to win prize(s)/reward(s) thereby creating an incentive based drive, desire, want to watch and/or listen to the commercial or multimedia message. We will define this system and method in future reference as IIDPS which stands for Interactive Incentive Driven Participatory System.

The present invention couples incentives, preferably in the form of a lottery/sweepstakes/raffle like event (without a purchase) program to query/question based participation and commercial/advertisement viewing and/or listening event. As a result, not only do consumers continue to watch and/or listen to the commercial program itself rather than fast forward, hop, surf away or mute it, but the consumers actually become engaged with the commercial material. Incentivizing viewers advantageously increases viewership while also increasing actual cognitive influence of the advertising message in the viewers mind. Overall impact and reach of the advertising messages are increased far beyond even current commercial influence and reach. By engaging the consumer, the likelihood of the consumer brand recognition, loyalty and desire to purchase and/or believe in the product, service, company, etc., increases.

Incentives are provided through the subject system and method to mobilize viewer watching of the commercial through interaction and participation. Each commercial can produce at least one prompt(s), preferably including at least two, and most preferably including three prompts, and/or a plurality of prompts. A ticket, representing one (1) chance/opportunity to win a single or multiple prize/reward from a given resource pool, jackpot, etc., is earned by the answering/interactive nature/participation through multimedia video/audio/internet medium(s) pertaining to but not limited to commercial viewing. This ticket enters the Active Commercial Viewer (ACV)/viewer participant into a free (to participant) lottery or broadcast/multimedia sweepstakes/lottery/raffle type event to be drawn at some pre-determined date/time. The broadcast sweepstakes/lottery/raffle type event can be for one or multiple prizes from college education stipends, vacations to small products. From large money prizes to gift certificates to appearances on television shows, movies, dinners with actors/actresses, etc. Prizes and rewards span a spectrum that is dependent upon the creativity and resources available of the advertising client, multimedia consulting/advertising/marketing companies and the show/event/company owners and any other accepted expert consultancy. The subject system and method provides for the binding of incentivized non-personally funded or other sweepstakes/lottery/raffle type event with a commercial or advertisement/marketing of any nature/model through an interactive medium that can register each participant's responses and interactions. This leads to the development and possible industry of non-network/channel commercials via any multimedia potential, for example on a website or other location, such as a channel/website for only commercials.

As used herein, the term Active Commercial Viewer (“ACV”) is intended to mean an audience member viewing and/or listening to a multimedia commercial or promotional event within a given show or time frame that becomes an active/activated participant engaged by and interacting with the system and method of this invention.

Consequently, the present system and method not only addresses problems in the art concerning the viewing of advertising media in the era of DVRs, but further increases the value of the advertisement itself by increasing cognitive involvement of the viewers/listeners. All advertising mediums can employ the subject system and method, including for example heretofore known and utilized mediums such as television commercials, radio advertisements, DVR playback technology itself, and/or digital video or programs on mobile devices and/or computer device. The incorporation of media other than video, digital, audio and Internet based is also seen as a possible in the framework of mass media including but not limited to newspapers, magazines, periodical, billboards, etc., where advertising clients/companies realize the need to link their multimedia/mass media campaigns and marketing strategies through this invented system and method. One such example would be the linking of a posed question/query on a billboard/print advertisement to specific commercial or promotional events or the coupled question of an aired commercial query asking for other information only found within mass media advertising. Reward could be multiple tickets issued for a correct answer instead of only one. The present system and method increases the likelihood of viewership of advertising media to provide higher-impact, deeper message penetration, objective measure of participation with definitive engaged participation and higher-audience reach of advertising messages.

Viewership incentives are provided that increase the likelihood the advertising ads will be viewed/listened to. Incentives placed by the network to answer queries/questions may further be provided within a certain time frame before during and after a broadcast. In one embodiment viewers can go, be directed to a website (to find specific show(s)), because they may not even like or follow a given show(s), to view the commercials only to answer the queries/questions in order to gain tickets and chances to win prizes, rewards, consolations of any type. Providing the ability to fast forward through the broadcast content just to have more queries/questions to interact with and answer and hence earn/have issued to them more tickets/incentives.

Broadcast networks generally attempt to generate an audience by content, originality, acting, reality, etc. Their goal is essentially to increase the number of viewers within specific targeted demographics. The more viewers, the more popular the show, and thus networks can charge more for air time. The present system and method adds to, and perhaps changes the traditional environment, by potentially driving an alliance between network and audience because of a shared goal; that being the larger the audience the potentially larger prizes, rewards and/or incentives. It thus would behoove the audience members to drive friends, family and social media contacts to their “favorite” or larger reward/prize based show(s). Favorite shows or broadcasts would translate to large audiences and bigger prizes. Further, networks may seek to enable these activities within their own marketing strategies. This is another value of the subject system and method. By providing/establishing a website(s) that centralizes the system's players and, by design of the website, connects the player's/viewer's social media connections. Thus, not only is the value of the present system and method to advertising apparent, but its value encompasses actual networks and stations by increasing the likelihood of listening/viewership of the programs/channel.

In a first embodiment, an IIDP system for enhancing the communication of advertising/marketing messages to viewers that incentivizes viewers to “engage” and even participate with the advertisement through the utilization of a prize/reward chance based lottery/raffle/sweepstakes through the issuance of earned unique tickets as understood in any lottery/raffle, etc., system based on chance and random drawing elements and as stated in whole or in part earlier in the specification. The subject invention enhances the achievement, attainment and exceeding of goals/strategies/and projections of advertisers toward their end users, customers or viewers. The system provides incentives in the form of but not limited to unique tickets (virtual, electronic or otherwise) to AVP's using a machine readable program storage device tangibly embodying a set of computer-readable instructions executable by the machine to allow the machine to interface with a system for enabling interactive participation by viewers and/or listeners viewing or listening to an advertiser's message, the machine having capability to receive and transmit messages, accept input via a user interface, and display messages on an electronic display. The system comprises: a) at least one advertising commercial or promotional event advertising at least a good, service and/or message having a set air length, event length and/or fixed/unfixed temporal component (if other than a televised or radio broadcast such as an internet based programming or website only event) and containing advertising content; b) at least one query set to be synchronized, transmitted and/or placed within the body of the advertising commercial and/or separate from the body of the advertising commercial and/or present as a part of the advertisement/commercial actual production, the query; c) at least one answer prompt being associated with the query adapted to prompt the viewers to respond and enter the answer through a wireless communication device, telephone, or computer device adapted to transmit and receive messages with the system; d) a central processing station or distributed processing stations for receiving, storing and computing points associated with the answers; and e) a central processor adapted to receive and process the viewer's answers into viewer points and market date. In another embodiment, the processor tracks: winners, losers, all information collected through the system, and prize disbursements. The process further runs analysis/comparative analysis, organizes shows, times, viewer engagement times, and changes to show times as well as any other metrics an artisan of the craft could enable and commercial/business clients would see fit to need/extract. Viewers are offered the incentives of earning tickets based on the viewer points earned (which could vary depending on the query setup and special offers made by supervising/licensed bodies involved, for example: 1 point=1 ticket, 2 points=2 tickets, etc.) for answering the opinion or factual based query, with the result that viewership and interactive, attentive and decision making (decisive) participation of the commercial is significantly increased.

An interactive incentive driven participatory (IIDP) system provides a method to incentivize viewer and/or listener participation of an advertising commercial or promotional message. The system is used in conjunction with a device having capability to receive and transmit messages and accept input via a user interface. An interactive website associated with software including entry of at least one advertising or promotional message, at least one query, at least one answer prompt and user information associated with a user of the machine. The website displays the advertising or promotional message and the query or queries to the user. The information of the website may also be displayed or audibly presented directly during a broadcast, Internet or multimedia event. At least one answer prompt is associated with the query adapted to prompt the user to respond. A central processing station receives, stores and assesses answers, and a central processor processes the user's answers into points/tickets correlating to incentives (chances for winning prizes, rewards, etc., as already stated in specification) and market data/analysis.

In a second embodiment, an interactive advertising system for providing an incentive drive for viewers/listeners of an advertising commercial to engage, stay tuned into the message(s) and interactively participate is provided. The IIDP system (as described in detail throughout this specification) is used in conjunction with ACV's employing a wireless device having capability to receive and transmit messages and accept input via a user interface. The system comprises: input via a user interface, and display messages on an electronic display. The system comprises: a) at least one advertising commercial or promotional event advertising at least a good, service and/or message having a set air length, event length and/or fixed/unfixed temporal component (if other than a televised or radio broadcast such as an internet based programming or website only event) and containing advertising content; b) at least one query set to be aired synchronized, transmitted and/or placed within the body of the advertising commercial and/or separate from the body of the advertising commercial and/or present as a part of the advertisement/commercial actual production, the query; c) at least one answer prompt being associated with the query adapted to prompt the viewers to respond and enter the answer through a wireless communication device adapted to transmit and receive messages with the system; d) a central processing station or distributed processing stations for receiving, storing and computing points associated with the answers; and e) a central processor adapted to receive and process the viewer's answers into viewer points and market data.

Viewers are provided incentives based on the viewer points for answering the query and viewership of the commercial is adapted to be increased.

A method for providing an interactive advertising system for providing incentives to viewers using a machine readable program storage device tangibly embodying a set of computer-readable instructions is also provided. The method's instructions are executable by the machine to allow the machine to interface with a system for enabling interactive participation by viewers or listeners viewing or listening to an advertiser message, the machine having capability to receive and transmit messages, accept input via a user interface, and display messages on an electronic display. The steps of the method include: 1) selecting at least one advertising commercial advertising a good, service and/or message having a set air length or event time and containing advertising content or communicative message intended for audience perception, reception and awareness to run during a program; 2) the advertising commercial having at least one query set to be aired within the body of the advertising commercial; 3) at least one answer prompt associated with the query, and adapted to prompt the viewers to respond and enter the answer through a wireless communication device adapted to transmit and receive messages with the system; 4) receiving and storing the answers of the viewers within a central processing station or distributed processing stations; and 5) computing viewers answers to extrapolate viewer points, conversion to tickets issued ACV's and market data collection. Viewers are provided the opportunity/chance at prizes and rewards via the lottery/raffle/sweepstakes like system which fosters the incentive to participate with the system and method of the invention based on the viewer's (ACV) personal reasons to gain/earn/score points leading to tickets or tickets for answering the query (correctly and/or even incorrectly) and viewership of the commercial is substantially increased.

The system is appointed to be utilized in a plethora of advertising mediums, including television, non-television based mediums, radio, internet, internet videos, and other current mediums provided. The system provides the ability to air queries or messages within commercials appearing on the screen appearing within the page of a designated website with or without the simulcast of the commercial or appearing as a recording during another event time (or audibly provided through radio), and/or the ability to notify viewers to go to a web page operated under the system that provides the queries for the viewers. As viewers enter answers they are provided points. The point system, as previously described, allows a multiplying conversion of points to tickets. A ticket is only one method, but perhaps the most commonly accepted method, for an individual or the system to be able to recognize if their number and/or unique definer/code issued to them has won or lost in a given round of a drawing, but not limited to said round, and may or may not be used again. As used herein, “ticket”, is only a descriptive term. Other terms may be employed depending upon the culture/country invented systems employed/used with reference to issues utilized in lottery drawing games or sweepstakes.

There is incentive for companies/sellers to band together under the auspices of a “program” that delineates an “event time”, outside of the single show that could encompass a time frame until the next show, or a week's worth of reruns of a particular show, or several different shows (with or without similar advertisers) banded together with a certain set time frame similar to the building period where people can buy a lottery ticket and allow the jackpot to accrue. With this approach and utilization of the invented system there will be a larger financial pool in which to create prizes from. This keeps advertisers and air time resellers as allies. Advertisers/corporations/etc., can further readily go to the system operator directly, bypassing traditional broadcast media and go directly through multimedia such as Internet based mediums utilizing the system and method represented within this specification, to either 1) very large commercial businesses/conglomerates that could use its divisions as separate advertising entities/commercial communications, etc, ask us to pool their individual commercials into “event times” that actually could be longer or any duration periods and run the commercials on the invented System's website(s) alone. In this use of the invention they would pay less for the commercial air or event time on line and offer much larger prizes since the system has lower operating costs as compared to networks/radio stations; and 2) companies that could not afford or it did not want single company event times could be placed together just as they would be within a television show, resulting in lower costs, which would allow larger prizes resulting in increased viewer attraction and the espoused potential and real benefits of this invented system and method. This direction would see the development of advertising/marketing within their brands to target and attract populations to their online event on the subject system, as well as using social media and even limited TV commercials that enabled viewers/players and captured their email/social media information upon sign-up to be players of the system. Upon sign-up viewers, ACV's/players are prompted to provide personal data information to determine demographics, age, gender, likes, dislikes, etc.

The system and method as one form of the embodiment, following all or some of the aspects hereinbefore described in connection with radio broadcasting and/or streaming, will direct listeners to specific website destination(s) where they can choose the station/program and time slot they were listening to and participate/interact with the commercials played during said program or event with query(s) and answer(s) in order to accrue points and tickets for winning within a set drawing associated with that program and perhaps associated programs.

### BRIEF DESCRIPTION OF DRAWINGS

The invention will be more fully understood and further advantages will become apparent when reference is had to the following detailed description and the accompanying drawings, in which:

FIG. 1 illustrates a flow schematic of an embodiment of the subject system and method;

FIG. 2 illustrates a schematic diagram of the flow schematic of FIG. 1;

FIG. 3 illustrates a schematic of a structure of the interactive advertising system and method of the present invention;

FIG. 4 is a schematic diagram of a television commercial being viewed real-time by viewers, in a home, in a business, and/or in a public place, utilizing the interactive advertising system and method of the present invention, showing a first query (beginning);

FIG. 5 is a continuation of the schematic diagram of the television commercial of FIG. 4, being viewed real-time by viewers, in a home, in a business, and/or in a public place, utilizing the interactive advertising system and method of the present invention, showing a second query (middle);

FIG. 6 is a continuation of the schematic diagram of the television commercial of FIG. 4, being viewed real-time by viewers, in a home, in a business, and/or in a public place, utilizing the interactive advertising system and method of the present invention, showing a third query (end).

### DESCRIPTION OF THE PREFERRED EMBODIMENTS

The present invention's system and method is directed to a computer readable program that incentivizes viewers to watch, interact, attend and utilize decision making (decisive) participation of viewed and/or listened to commercials. Viewers or ACVs, as earlier defined, respond to queries strategically placed throughout the duration of a commercial. Correct responses or simply answering an opinion based, non-factual query/question earn points, tickets or coupons which are used to determine a unique signature/signal and placed in a lottery/raffle or sweepstakes like pool, the winners of which receive monetary or other types of prizes (the incentives), such as college education stipends, products, gift certificates to appearances on television shows, movies, dinners with actors/actresses, and the like.

The subject system method runs as an interactive program on the system's website displayed on a display of a computer, Smartphone, tablet or mobile device, or stationary device. A mobile icon executing a mobile application of the system is also preferably provided. The icon system is constructed having an interactive messaging icon associated with software that includes entry of viewer user information and advertiser queries and incentives data. As an example, a television program (or other broadcast/multimedia medium) could run a spot before the show detailing the rules, the rewards, how to participate in various ways, close caption turn on, etc. Interactive viewers would be on the website during the show and viewing questions associated with their commercials. Commercials would run as well depending upon connection speed of device. It is contemplated that industry will see a slowing down of show viewing in “real time” as viewers pause the show to finish the commercials and answer queries. Where DVR and advancing technology is currently the enemy, the system herein transforms it into an ally.

Modern problems of declining viewership of television commercials owing to DVR devices and the like that allow viewing of television programs or movies while skipping commercials are solved through the subject interactive system and method. Additionally, the subject system and method mitigate dilemmas that exist concerning channel surfing away from commercial breaks to the hundreds of other channels to view while the commercials run. Also 30 second skips etc.

Viewership (of commercial image or sound) is increased (over traditional commercial only advertising or other models) through use of the subject system and method by taking any commercial and designating at least three specific elements within the composition at the beginning, middle and end of the commercial. These elements are then queried for identification by the viewer who is prompted to either click on the correct answer to a query or click on an answer to a posed question with or without elements from within the embodiment of the commercial itself. The query may be opinion based and structured for marketing research data collection.

Television and radio advertising generally involves two main tasks, the first is creating an advertisement that meets broadcast standards, and the second is placing the advertisement in keeping with considerations of targeted air time and programming to reach the desired customer. Advertising viewership is capable of being measured via measurement of television program viewership, typically via the Nielsen ratings system. This measurement provides a means for television broadcasters to determine how popular a given television program is, and in turn in deciding the rate to charge advertisers for air time. Today, a typical sixty minute long television program has forty two minutes of program air time and eighteen minutes of commercial air time spaced therein. A typical thirty minute television program includes twenty two minutes of program air time and eight minutes of advertisements. The average length of a television or radio commercial ranges from about ten seconds to one minute, with 30 seconds being the average time length so that more advertisements are shown during each program commercial break.

The present invention is directed to a real-time as well as virtual time system where shows can be watched off hours via the internet or replayed at some later time because they were recorded. The system also provides for commercial only programming via the Internet whether it is on the system's website or through an agreement with burgeoning web television channels such as You Tube or Google TV.

The present invention is directed to an interactive advertising message enhancement system and method that prompts consumers with messages, promotions, queries and/or quizzes during advertising commercials to incentivize viewers to watch and/or listen to the commercial and participate in an interactive manner that demonstrates knowledge and awareness of the commercial, to some degree, from beginning to end or some point near the end of the commercial run. As a result, not only do consumers continue to watch/listen/or listen to the commercial program itself rather than fast forward, hop, mute it, etc., but the consumers actually become engaged with the commercial material. Incentivizing viewers to actively/interactively participate advantageously increases viewership as well as ownership/embedding of the commercials content and message while also increasing actual cognitive influence of the advertising message in the viewer's (ACV's) mind. Overall impact and reach of the advertising message(s) are increased far beyond even current commercial influence and reach. By engaging the consumer, the likelihood of the consumer's brand recognition, purchase reasoning and potential/real loyalty increases. The interactive nature of the invention allows for a depth of collection and flexibility of marketing research never before seen by commercial advertising. The invention is and defines an advertising as well as marketing enhancement system that is a superior solution to what is attempted today and a uniquely blended method to create incentive driven, volitional participation of the audience or portions therein.

In a preferred embodiment of the subject system and method a website operated with software is provided wherein the website provides queries related to commercial spots within a broadcast, with/or without the commercial playing. Most advantageous is for the system to have the commercials and questions all ready available and running so the system players/viewers can be viewing queries in the queue in advance of the commercial, or better yet they are watching the commercials ahead of time. For example, a banner can run for the system's website (“Go To specific website X”) and all the winners and prizes of the system may further be run on a banner on the broadcast. In one embodiment the commercials are queued and available without queries, and then the queries pop up as the commercial plays during its spot/position within the allotted air time. As a result, viewers are watching the commercials beforehand and at the time of their spot run. Advantageously, by doing this, viewers may watch the commercials more than once.

As viewers play on the system they collect points/tickets. Preferably the points/tickets are connected to viewer users social media pages, etc., showing the number of points/tickets and wherein special offers of extra tickets can be offered for those viewer users who post their winnings directly to their social media accounts. Thus providing further negotiation ability with companies such as social media companies, including for example that associated with the trade name Facebook, where they may get more accounts simply because viewer users (ACVs) want the extra tickets/points.

In another embodiment, the system and method of the present invention provides for at least one query at a selected time within a commercial itself. Being that the average length of a commercial ranges from ten seconds to one minute, the timing of the query can be determined based on each commercial length as a time percentage placement within the commercial. For example, if the query is set to run towards the beginning of a commercial, the query time set can be set at 5% air time. That is to say, if the commercial is a 10 second commercial, 5% air time of the 10 second commercial would result in the query airing at 0.5 seconds from air time start (10 second×0.05=0.5 seconds). If the commercial is a 1 minute length commercial, and the query is set in the beginning at 5% air time in the 60 second commercial, the query would air at 3.0 seconds from air time start (60 seconds×0.05=3 seconds). So on proportional query start times are provided depending on the length of the commercial and the set query set run time. Query time sets can be set at a range of about 1% to 100% start time based on the commercial length; preferably, the query time range is set at about 3% to 90% start time based on the commercial length; most preferably, the query is set to start at 10% start time based on the commercial length.

In an alternative embodiment, the query and answer time expires at a much later time, for example the expiration time may expire after two months from air date so that even if the program is being watched by DVR playback, the viewer is still interested in viewing the commercials to enter to win prizes, rewards, offers, promotions, discounts, gift cards, and/or free goods and/or services. The expiration date of the embedded query and answer is adapted to be set by the advertiser and/or network, which in turn is predicated on the advertiser's or networks desired run length of the given promotion, previously described.

Each answer time for a query is also set to run for a given amount of time. This time frame is also preferably proportionally based on the commercial length itself; however the length of response time may run longer if the program the commercial is airing in provides for the ability to illicit the response at a later time in the program (rather than only within the commercial body itself). Alternatively, a given manufacturer of the same brand or other owned brands may allocate query and answering prompts related to another commercial within a later aired commercial or event or co-related event, preferably within the same television program or show but not necessarily. Answer time sets preferably, and follow a common sense approach as would be agreed to by most people polled and or users of system and method, begin immediately upon display or presentment of the query; and the viewer is typically given a set amount of time to respond. The time out or set for answering would be set prior and by the program/event owner with/without agreement of advertisers/clients. This is a common sense approach in order to create a finite period to determine a ACV's play, responses and point and/or ticket allocations/issuance. If time exceeded then that commercial round is nullified although the other commercial/advertising rounds would remain open. A round may be distinguished by a commercial break during a show or a start time of a singular commercial run within an online event. An example being a ACV begins a commercial with query/answer portions available for interactive participation based on commercial content/message(s) and said commercial is 60 seconds in length. As one possible manifestation of the embodiments the round may be open for three minutes in which time it will close and no longer recognize answers/prompts, etc. The ACV will be issued points/tickets based upon whatever questions were answered correctly or answered for opinion only query.

Preferably, the user is given a reasonable amount of time to respond and depending upon the medium used for the system as well as the technology of the user/ACV it can vary.

There are different time sets or rounds to consider.

First is the length of time a series or set of commercials from a 30/60 or more television/radio show will remain open. Those ACVs who have DVR technology can pause the show and answer the online query/questions while watching/reviewing if needed the commercials online if available to their technology.

Those without DVR technology will heavily rely on the website resources and/or answer the queries briskly. With commercial advertisements ranging from approximately 16 for a 30 minute program (by some statistical measures) to over 30+ for an hour program we are looking at an engagement of time to interact and participate with the commercial advertisements through the invented system.

Then there is the time set and round for answering the individual commercial's query set/or single.

The time set and/or round for each can and should be set by the program ownership with/without advertisers input. The system owner always maintains the right of intercession if the times are set inappropriately for proper player interaction and response.

Preferred time set or round may be in 60 minute time limits to facilitate response to the entire round of commercials within the event; although longer and shorter periods can be used as well.

Preferably, in the query/answer time set a ACV/user/player is given 20 minutes to respond; most preferably the user/viewer are given 10 minutes to respond before the query expires. In this manner, the query is typically not available during later playback, as it has expired. The system and method accounts for a start time that may or may not be associated with a show/program or messages original run time or airing. The timer would only begin running once the ACV started watching and more importantly, for the system, playing/starting a given commercial and participating in the query/answer interaction.

It is recognized and understood that a ACV may start a commercial or event run and only participate in a portion of the total set of commercials/advertisements for whatever reason(s). They may or may not be granted the entire time set for all commercials within that run or string.

They may or may not be granted the ability to later access the commercial(s) they missed in that string or run.
The preferred embodiment and use of the system and method would be for ACV to be allowed time and opportunity to actively participate to their best ability in order for them to have the greatest opportunity and chances to win/earn rewards/prizes, etc. In addition this preferred embodiment allows for the greatest collection of research data, message penetration and participant focused viewing of the commercial and its elements. This preferred method and/or embodiment would therefore allow gaining access back into a commercial advertising string or event or commercial break.
It is known and understood that participating in the same commercial multiple times is allowed for the very reason that the same commercial is often run multiple times within a given show, air time, or event. Queries will/may be changed in order/content to make the interaction different. The owner and/or licensee has the power to limit the number of participations.

Answer time sets preferably begin immediately upon display or presentment of the query and preferably do not expire until the advertiser's promotion or deal is not longer active; time sets can run for several days or up to the next show time week, or for several weeks, months, or for a year—as long as the advertiser desires. Taking into account reruns of old shows, daily shows such as news programs, cartoons, etc., the focus is not on the immediacy of response but rather gives a fair amount of time for participants to get around to seeing their show and interacting actively with the system.

So even for daily shows there may give a three day grace period. Ex. Monday News at 6 has a period of three days until 5 o'clock on Thursday when the system drawing occurs. Periods are created for each show and these periods are sent to the participants. The system processes, tracks and maintains all show viewings, participant logins to the system as well as tracking answers and its viewer user/player demographic data.

At least one query is provided. More preferably, at least two queries are provided. Most preferably, at last three queries are provided. The number of queries provided is selected by the advertiser and/or network and is typically dependant on the length of the commercial spot. For example, for a ten second commercial spot, it would be difficult to run more than one query. Conversely, for a one minute commercial spot, it would be feasible to run two or even three queries.

Where a second and third, etc., query is to be run, the time percent allocation as set forth above concerning the timing of the first query can readily be employed. Wherein the first query may be set at a 10% commercial air time (based on the commercial length), the second query may be set at a 20% commercial air time (based on the commercial length), and the third query may be set at a 50% commercial air time.

In a preferred embodiment, there are a plurality of queries without limit on time constraints in taking into account playback pause features wherein viewer players can pause the screen to answer and/or have an extended period of time after the show as well and can go to system website to watch commercials again. A range of options are provided through the system, for example a show producer may desire to get viewers watching the show in its time slot for ratings reasons and may offer “double tickets/points” for those who participate through the subject system website or directly via mobile devices.

Queries are determined by the advertiser and/or network/third party and are preferably based on predominant elements within a commercial. In one embodiment queries are already posted with the commercials; in another embodiment the commercials are queued and can be viewed ahead of time perhaps even before the show begins and the queries post just prior to the place in the commercial where the answer will appear.

Answers to the queries may result in point issuance, or ticket issuance. A given number of points may result in a ticket, a coupon, or other promotion. Alternatively, a ticket may be issued for a single point/or points tallied result as tickets given to the viewer/player. In turn the tickets may be entered for a lottery or sweepstakes event. For some queries there may be no wrong answer and simple completion earns a ticket/point. Where there is a right/wrong then a ticket may or may not be dispersed.

FIG. 1 illustrates a flow schematic of an embodiment of the subject system and method. FIG. 2 illustrates a schematic diagram of the flow schematic of FIG. 1. Referring to FIGS. 1 and 2, the interactive incentive driven participatory system is shown generally at 1000. The system 1000 provides incentives to viewers of an advertising commercial or promotional message and is used in conjunction with a device having capability to receive and transmit messages and accept input via a user interface. The subject system method runs as an interactive program on the system's website via an interactive incentive website at 1001 associated with software including entry of at least one advertising or promotional message, at least one query, and user information associated with a user of the machine shown at 1050 in FIG. 2. A television program (or radio broadcast; internet video) runs a spot before the show detailing system—setting forth the website address to visit, the rules, the rewards, how to participate in various ways, close caption turn on, etc., shown at 1002. Interactive viewers log onto the system website during the show and view questions associated with their commercials—viewers can pause the show—shown at 1003. Commercials run as well depending upon connection speed of device, shown at 1004.

The website displays the advertising or promotional message and the query to the user. The information of the website may also be displayed or audibly presented directly during a broadcast. At least one answer prompt is associated with the query adapted to prompt the user to respond. A central processing station receives stores and assesses answers, and a central processor processes the user's answers into points/tickets correlating to incentives and market data.

Commercials utilizing the subject system and method can be traditional and unmodified commercials or can be specifically designed toward ensuring/engaging viewed participation/interest, evoking/extracting consumer or non-consumer information/opinions/needs/desires based upon the context/construction of the specific questions and answers. Commercials can be designed to have more than one type of question/answer survey format and intended outcome measure or viewer influence. Commercials can be made with additional segments to be placed within the body of the commercial to give a wider range of possible queries in order to extract additional marketing research data or other information.

If a commercial has three queries there are then three (3) different versions of presenting the queries by simply re-arranging the order of the questions/queries. However, if the commercial is designed in such a way as to have nine (9) possible queries then there are 504 possible permutations of three queries.

The medium of interaction includes any type of interactive based program designed to prompt the viewer while watching any given commercial. There can be a temporal correlation built in or not. In other words the network or channel or internet vehicle, commercial space's buyer (client, seller) or other can choose to engage a specified time period for viewing the commercial(s) and answer the queries specific to that commercial.

Time periods, frames in which to have questions for the commercials answered and/or the timeframe a specific commercial or video/audio sale/poll/study/query must be answered in order to prevent fraudulent interactions. Periods examples can be by show end, by the next new show of that season, by midnight of that day (for reruns), 24 hours, etc. This prevents or mitigates viewer participant deception(s). Commercials are preferably designed with multiple random question/queries for each in order to deny individuals not watching the commercial from getting mass info from an outside source to make the process of the subject system and method easier/faster. Use of random bonus questions may be introduced which allows for entry into a special drawing, which in turn mitigates cheating. Bonus question must be answered in order to get issuance of other points/tickets in that commercial.

Incentives are provided through the subject system and method to mobilize viewer watching of the commercial through interaction and participation. Each commercial can produce at least one prompt(s), preferably including at least two, and most preferably including three prompts, and/or a plurality of prompts. A ticket is earned by the answering/interactive nature/participation through video/audio medium pertaining to but not limited to commercial viewing. This ticket enters the Active Commercial Viewer (ACV)/viewer participant into a free (to participant) lottery or broadcast sweepstakes to be drawn at some pre-determined date/time. The broadcast sweepstake lottery can be for one or multiple prizes from college education to small products. From large money prizes to gift certificates to appearances on television shows, movies, dinners with actors/actresses, etc. The subject system and method provides for the binding of incentivized non-personally funded or other lottery or sweepstakes with a commercial or advertisement/marketing of any nature/model through an interactive medium that can register each participant's responses and interactions. This leads to the development and possible industry of non-network/channel commercials, for example on a website or other location, such as a channel for only commercials. This method as outlined can be utilized outside of television programming and placed within known mediums (i.e. YouTube, websites, channel for only commercials and prizes, etc.) as well as unknown future mediums. An extrapolation of this concept/idea is that prizes and their numbers or values will/can increase as the viewership of a show or program increases. This creates a natural drive as well as an opportunity for an exploitation effect as it adventitiously gets existing viewers to enroll family, friends, and/or others to participate/view/show/commercials in order to gain market share, grow viewership and increase show revenues which could reflect back in higher jackpot pools. The subject system and method allows for increased pricing of commercials, increased commercial revenue and the financial ability to offer increased prize numbers and values.

Additionally this concept allows for the specific targeting and polling of consumer, electronic, population(s), ethnicity, cultures, etc. via commercial and query designs. This would create large amounts of demographic/consumer profile information that could be owned by the holder of this patent and/or licensee(s) and re-sold, combined, etc.

Viewers can use their personal wireless mobile device to interact, view queries, view communications and promotions or messages, and answer questions or prompts. The structure of the subject system and method offers the ability to provide encryption in the commercials, read, interact, view queries, hear queries (radio, audio aspect), collect, collate, identify, define parameter, choose winners, connect with winners, and use population of participants to market directly to consumers as well as other abilities implicit and inherent in this invention design.

A network (with autonomy or with the input of its commercial clients) can define a variable prize value if a user participates with the system and method to interface with the commercials while watching a show, in order to further encourage consumers to stay on and watch a given television program or listen to a given radio station. In one aspect of the subject invention advertisers can go to an online site to place an advertisement, commercial or promotion and forego the higher prices of television commercial slots, or in addition to utilization of television commercial slots.

Hosting viewer/query interface is achieved through the platform of the subject system and method. In addition to creating and hosting the viewer/query interface, the system is capable of 1) creating and tracking answers entered by a user through identifying a user through his/her mobile device or device identification or IP address as one possible identifier (someone may use another's phone, be at a public library, etc) but also identified by their username and password which would be established when they signed up on the system website and also gave us their address, phone numbers, personal demographics, etc, etc. The system is further capable of controlling the mechanisms of the sweepstake or lottery system with dispensation of prizes. Interface with demographics/marketing software/engine capability is also provided through the system through entry of user information in registering or logging into the application of the system. The system is capable of handling other link functions that run with the primary operating software. For example, including the linking to secondary markets and running the subject system's interactions with local/regional/national and/or international companies who's economics/advertisement budget can only allow for a smaller marketing exposure. Second tier would be perhaps local larger businesses who make commercials but run them on smaller cable stations within a limited geographic and third tier would be smaller businesses who cannot afford commercial advertising.

Second tier could get a larger geographic from the subject system and method if they promote for example a new car giveaway through the system's lottery where we would promote the commercial view online by posting to their social network (better so all their social media contacts can see and perhaps join/play) or sent directly to their email. They can also give smaller prizes (discounts) that would act as fodder giveaway and add (at no additional cost to network or commercial client) to overall prize pool so that more players “win” something and get positive re-enforcement of the system.

Third tier would give coupons/gift certificates/traditional advertising material they use and get market recognition as we send out to prizes to winners (which could be all players within specific zip codes. This creates a “better” direct mail campaign as players are receiving this as “winnings”. These customers may also purchase banner ads, side panel ads, etc. on the system websites that will only play within the restricted local zones, etc.

FIG. 3 illustrates a schematic of a structure of the interactive advertising system and method of the present invention, shown generally at 100. Preferably a cloud computing server 103 is utilized in the platform with readable programmable software of the subject system which may be a physical location, website, database resident of a server, and is accessed by the mobile devices, such as smart phones, cellular phones, mobile tablets and/or other mobile devices used by viewers shown at 105. Server 104 controls the system's functionality by performing detailed processing. The database in a server 104 includes commercial ad data, as well as the queries, query set times, content, answers, answer set times, responses, viewer point tabulation, and promotions, etc. going toward the queries. Cloud based applications may be used for delivery of content to the mobile device. The database server 104 (or a plurality of servers) has information of a number of advertising groups and may include promotions, images, advertisements, coupons, rebates, and the like. The system and method may be linked through users/viewers via an application such as a smart phone or mobile tablet app. In this manner, a viewer can simply log into or activate the app on the mobile device and enter his/her responses without needing to dial in or email in the responses to each query.

Mobile devices contemplated preferably include hand held interactive devices adapted for use in connection with the interactive advertising message and viewer participation system of the present invention. Alternatively, the device may be a remote control device provided in association with the system, and/or a gaming device provided with a gaming system that allows internet connectivity, for example such as that offered under the trade name Wii. Generally, the device includes housing with an electronic display, and multiband radio incorporated therein with an audio receiving circuit and an audio output means. The audio output means is in electrical communication with the audio receiving circuit in a manner known in the art. The radio is adapted to receive AM, FM and/or VHF signals from a number of predetermined frequencies. The electronic display is in electrical communication with a local microprocessor mounted within the housing. A transceiver in electrical communication with the local microprocessor allows for the transmission and receipt of data from a central processor in a manner known in the art. The electronic display is adapted to display data received from the local microprocessor.

Answers or responses from the viewers are transmitted to a central processor that tabulates the answers to determine correctness and to generate points to a given viewer if the answer is correct. The processed information is stored and displayed to the viewer, either on the device via an email/text message to the viewer, or the first viewer with the most points may be displayed as the winner on the television screen/or announced on the radio program after a given amount of time and points have been accumulated. In a preferred embodiment, view users are given points/or tickets for each answer given. Fewer tickets may be given for incorrect answers, while a greater number of tickets (or tickets of greater value) may be given for correct answers. The tickets may then be used in a lottery or sweepstakes wherein a winner is determined.

Processed information is further adapted to be compiled in correlation to each viewer, including demographic, gender, age, etc. associated therewith, in order to provide marketing data and information to the advertiser and/or network. Answers of the viewers are transmitted to a receiver or receivers, either at a central processing station or at distributed processing stations. The answers are stored as viewer data for processing the data and storing same for promotional purposes, marketing purposes, or the like.

The results of the processing of the viewer answers takes place after the processing of the viewer answers, providing substantially instant feedback to the viewer, showing the viewer if their answer was correct and, if correct, the number of points, tickets, or points with resulting in ticket issuance allocated to the correct response. If the answer is incorrect a fun or comical message may be sent to the user, for example, “wake up”/or something comical or satirical to that effect. If someone gets a query wrong, the system may report it in a funny way and give them a grace period, for example to re-answer/try again within 10 minutes of show/air time ending, after instantly feeding back to the viewer that their answer was incorrect. Effectively, this approach makes the viewer go back and view the commercial or portion again, giving advertisers/networks even more potential commercial message embedding/viewing.

Technology known in the art can readily be employed for carrying out the steps of encrypting (either beforehand or live encryption) of the commercial, querying the viewers at given times selected during the commercial, transmitting, receiving and storing the answer responses from the viewers, and collating the responses to generate text or email messages. Additionally, querying and transmitting are preferably achieved using wireless communications known in the art. Wireless communications are preferably selected from the group consisting of radio transmissions, microwave transmissions, broadband wireless data transmissions, and satellite transmissions.

Based on points, tickets or prizes earned by the viewer, the viewer can receive promotional offerings, such as for example, electronic coupons, electronic gift cards, promotional codes, and/or free samples. The viewer may elect to bank points with a given advertiser to accumulate more points for a larger prize offering.

The present invention may be embodied in other forms without departing from the spirit or essential attributes thereof and accordingly reference should be made to the claims rather than to the foregoing specification as indicating the scope thereof.

FIGS. 4-6 illustrate schematic diagrams of a television commercial being viewed real-time by viewers, in a home, in a business, and/or in a public place, utilizing the interactive advertising system and method of the present invention. FIG. 4 shows a first query airing toward the beginning of a commercial. FIG. 5 shows a second query airing toward the middle of the commercial. FIG. 6 shows a third query airing toward the end of the commercial.

Referring to FIGS. 4-6, in the example commercial three elements of commercial “X” are designated by the network, third party, or advertising client. Commercial “X” begins with three cars in a line and is shown at 11 aired on a television screen (or computer or mobile device screen).

Query 1 shown at 12 in FIG. 4 appears on the television screen 11 (or mobile device screen, or computer screen, or other device) asking: “How many cars do you see at the start of the commercial?” Answer selections, shown at 13, appear on the screen 11 and include prompts for “1 car, 2 cars, 3 cars, or 4 cars”. A phone number for the text message of the answer 13 is provided within the prompt; alternatively an email address of the advertiser, network or third party is provided to receive the viewer's answer. The viewer is then prompted to select his/her answer from the answer selections 13 and a score is generated (correct/incorrect) at 14. Any apparatus that utilizes the internet, wireless, cable, satellite communications connectivity in order to fulfill the obvious and implied intents of this intellectual concept can be utilized in implementing the subject responses.

Query 1, shown at 12, is set to start toward the beginning of the commercial. The commercial of the figures, for this example, is a 60 second length commercial. Query 1, shown at 12, in this example is selected by the advertiser, network and/or third party to run towards the beginning of a commercial, set at 5% air time. Meaning that because the commercial in the example is a 60 second length commercial, 5% air time Query 1, shown at 12, is set to air at 3.0 seconds from air time start (60 seconds×0.05=3 seconds) or within 3.0 second of the start of commercial “X”.

Answer selection, shown at 13, appears nearly immediately and simultaneously with Query 1. Answer selection, shown at 13, is also set to run or remain open for response for a given amount of time—or via an Answer selection, shown at 13, open time frame. This time frame is also preferably proportionally based on the commercial length itself; however the length of response time may run longer if the program the commercial is airing in provides for the ability to illicit the response at a later time in the program (rather than only within the commercial body itself). Preferably, the Answer selection, shown at 13, open time frame provides 60 minutes for the response before the query expires; more preferably, the user is given 20 minutes to respond; most preferably the user/viewer is given 10 minutes to respond before the query expires. In an alternative embodiment, the Answer selection, shown at 13, expires at a much later time, for example the expiration time may expire after two months from air date so that even if the program is being watched by DVR playback, the viewer is still interested in viewing the commercials to enter to win offers, promotions, discounts, gift cards, and/or free goods and/or services.

Query 2 shown at 22 in FIG. 5 appears on the television screen 11 (or mobile device screen, or computer screen) during the middle of the commercial via Query 2 air time, asking: “What does the blue car do?” Answer selections, shown at 23, may include: “A. Make quick turns; B. Turn into the newer version; C. Change color; D. Park itself” The viewer is then prompted to select his/her answer 23 and a score is generated (correct/incorrect) at 24. As set forth hereinabove referring to Query 1 in FIG. 4, the phone number for the text message of the answer 23 is provided within the prompt; alternatively an email address of the advertiser, network or third party is provided to receive the viewer's answer.

Query 2, shown at 22, is set to start toward the middle of the commercial. The commercial of the figures, for this example, is a 60 second length commercial. Query 2, shown at 22, in this example is selected by the advertiser, network and/or third party to run towards the middle of the commercial, set at 40% air time. In other words, because the commercial in the example is a 60 second length commercial, 50% air time Query 2, shown at 22, is set to air at 30 seconds from air time start (60 seconds×0.50=30 seconds) or within 30 seconds of the start of commercial “X”. Answer selection, shown at 23, appears nearly immediately and simultaneously with Query 2. Answer selection, shown at 23, is also set to run or remain open for response for a given amount of time—or via an Answer selection, shown at 23, open time frame. This time frame is also preferably proportionally based on the commercial length itself; however the length of response time may run longer if the program the commercial is airing in provides for the ability to illicit the response at a later time in the program (rather than only within the commercial body itself). Preferably, the Answer selection, shown at 23, open time frame provides 60 minutes for the response before the query expires; more preferably, the user is given 20 minutes to respond; most preferably the user/viewer is given 10 minutes to respond before the query expires. In an alternative embodiment, the Answer selection, shown at 23, expires at a much later time to entice and/or allow viewership during later DVR playback.

Query 3 shown at 32 in FIG. 6 appears on the television screen 11 (or mobile device screen, or computer screen) toward the end of the commercial via Query 3 air time, asking or prompting the viewers: “Finish the sentence: Brand X, we make them ______ than the rest!” dial “1-800-Xadquery” and select A. Faster #, B. Cleaner #, C. Sexier #, or D. Better #. The answer selection is shown at 33, and is based on the content in the commercial as one of the elements the advertiser, network or third party focused on. The viewer is then prompted to select his/her answer 33 and a score is generated (correct/incorrect) at 34. As set forth hereinabove referring to Query 1 in FIG. 4, and Query 2 in FIG. 5, the phone number for the text message of the answer 33 is provided within the prompt; alternatively an email address of the advertiser, network or third party is provided to receive the viewer's answer. In an alternate embodiment, a phone number can be provided wherein a user can call in and link to an already established system player/viewer account.

Query 3, shown at 32, is set to start toward the end of the commercial. The commercial of the figures, for this example, is a 60 second length commercial. Query 3, shown at 32, in this example is selected by the advertiser, network and/or third party to run towards the end of the commercial, set at 90% air time. Because the commercial in the example is a 60 second length commercial, 90% air time Query 3, shown at 32, is set to air at 54 seconds from air time start (60 seconds×0.90=54 seconds) or within 54 seconds of the start of commercial “X”. Answer selection, shown at 33, appears nearly immediately and simultaneously with Query 3. Answer selection, shown at 33, is also set to run or remain open for response for a given amount of time—or via an Answer selection, shown at 33, open time frame. This time frame is also preferably proportionally based on the commercial length itself; however the length of response time may run longer if the program the commercial is airing in provides for the ability to illicit the response at a later time in the program (rather than only within the commercial body itself). Preferably, the Answer selection, shown at 33, open time frame provides 60 minutes for the response before the query expires; more preferably, the user is given 20 minutes to respond; most preferably the user/viewer is given 10 minutes to respond before the query expires. In an alternative embodiment, the Answer selection, shown at 33, expires at a much later time to entice viewership during later DVR playback.

A user may respond to just one of the queries in FIGS. 4-6, or may respond to as many queries as he/she desires; including responding to all the queries. The more responses, and particularly correct responses, the viewer submits, the more points the viewer receives.

Subliminal images, such as that shown in FIG. 6 at 50, can be placed within the ad to impact the viewer in a positive, impacting influence toward the product, message, service, etc. This interactive relationship between commercial: (to) product/service/message and viewer/buyer/market is achieved via computer/cell phone/smart phone/iPad or computer pad of any make/landline phone, etc. Any apparatus that utilizes the internet, wireless, cable, satellite communications connectivity in order to fulfill the obvious and implied intents of this intellectual concept can be utilized in implementing the subject responses.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An interactive incentive driven participatory system for providing incentives to viewers using a machine readable program storage device tangibly embodying a set of computer-readable instructions executable by the machine, the system comprising:
a an interactive incentive website of the system associated with software including provisions for entry of at least one advertising or promotional message, at least one query, and user information associated with a user of the machine;
b the interactive incentive website being displayed through the Internet connectivity displaying the advertising or promotional message and the query to the user;
a at least one answer prompt being associated with the query adapted to prompt the user to respond and enter the answer through the machine;
b a central processing station or distributed processing stations for receiving, storing and assessing answers;
c a central processor adapted to receive and process the user's answers into viewer points or tickets and market data;
wherein the users are provided incentives based on the viewer points or tickets for answering the query and viewership of the commercial is substantially increased.

2. An interactive incentive driven participatory system for providing incentives to viewers as recited by claim 1, wherein the website has an address that is displayed on a screen associated with a broadcast.

3. An interactive incentive driven participatory system for providing incentives to viewers as recited by claim 1, wherein the website has an address that is audibly provided in association with a broadcast.

4. An interactive incentive driven participatory system for providing incentives to viewers as recited by claim 1, wherein the machine is a wireless communication mobile device comprising a cellular phone, Smartphone, mobile tablet and laptop computer.

5. An interactive incentive driven participatory system for providing incentives to viewers as recited by claim 1, wherein the website is executable by through an icon application linked with the website and software thereof.

6. An interactive incentive driven participatory system for providing incentives to viewers as recited by claim 1, wherein at least two queries are presented in the advertising message.

7. An interactive incentive driven participatory system for providing incentives to viewers as recited by claim 1, wherein at least three queries are presented in the advertising message.

8. An interactive incentive driven participatory system for providing incentives to viewers as recited by claim 1, wherein the query is integrated within the body of the advertising message and the query concerns content within the advertising message.

9. An interactive incentive driven participatory system for providing incentives to viewers as recited by claim 1, wherein the query is not integrated within the body of the advertising message, and wherein the query concerns content within the advertising message.

10. An interactive incentive driven participatory system for providing incentives to viewers as recited by claim 1, wherein the query is not integrated within the body of the advertising message, and wherein the query concerns content associated with a brand.

11. An interactive incentive driven participatory system for providing incentives to viewers as recited by claim 1, wherein the query is integrated within the body of the advertising commercial during airing of a program through streaming of content based on content within the program.

12. An interactive incentive driven participatory system for providing incentives to viewers as recited by claim 1, wherein the query is directly related to content within the advertising or promotional message.

13. An interactive incentive driven participatory system for providing incentives to viewers as recited by claim 1, wherein the user's answers are converted to points which are provided to the user as tickets that are used in a lottery or sweepstakes game operated by the system.

14. An interactive incentive driven participatory system for providing incentives to viewers as recited by claim 1, wherein the user's answers are converted to tickets that are used in a lottery or sweepstakes game operated by the system.

15. An interactive incentive driven participatory system for providing incentives to viewers as recited by claim 1, wherein the user's answers are assessed for correctness/incorrectness and if incorrect a prompt is presented to notify the user of the incorrect answer.

16. An interactive incentive driven participatory system for providing incentives to viewers as recited by claim 1 further being linked to at least one social media website.

17. An interactive incentive driven participatory system for providing incentives to viewers as recited by claim 16, wherein bonus tickets or promotions are awarded to the user based on the linkage to the social media website.

18. An interactive incentive driven participatory system for providing incentives to viewers as recited by claim 1, wherein viewer points correlate to promotions transmitted to the viewer, including electronic coupons, discounts, gift cards, and free goods and/or services.

19. An interactive incentive driven participatory system for providing incentives to viewers using a machine readable program storage device tangibly embodying a set of computer-readable instructions executable by the machine to allow the machine to interface with a system for enabling interactive participation by viewers or listeners viewing or listening to a message, the machine having capability to receive and transmit messages, accept input via a user interface, and display messages on an electronic display, the system comprising:
a at least one advertising commercial advertising a good or service having a set air length and containing advertising content;
b at least one query set to be aired within the body of the advertising commercial, the query;
c at least one answer prompt being associated with the query adapted to prompt the viewers to respond and enter the answer through a wireless communication device adapted to transmit and receive messages with the system;
d a central processing station or distributed processing stations for receiving, storing and computing points associated with the answers;
e a central processor adapted to receive and process the viewer's answers into viewer points and market date;
wherein the viewers are provided incentives based on the viewer points/tickets for correctly answering the query and viewership of the commercial is substantially increased.

20. An interactive incentive driven participatory system for providing incentives to viewers as recited by claim 19, wherein the wireless communication device includes mobile devices comprising cellular phones, Smartphones, mobile tablets and laptop computers.

21. An interactive incentive driven participatory system for providing incentives to viewers as recited by claim 19, wherein at least two queries are presented in the advertising commercial.

22. An interactive incentive driven participatory system for providing incentives to viewers as recited by claim 19, wherein at least three queries are presented in the advertising commercial.

23. An interactive incentive driven participatory system for providing incentives to viewers as recited by claim 19, wherein the query is integrated within the body of the advertising commercial and the query concerns content within the advertising commercial.

24. An interactive incentive driven participatory system for providing incentives to viewers as recited by claim 19, wherein the query is integrated within the body of the advertising commercial during airing of a program through streaming of content based on content within the program.

25. An interactive incentive driven participatory system for providing incentives to viewers as recited by claim 19, wherein the at least one query integrated within the body of the advertising commercial is set to air at a query air time proportional to a commercial length as a time percentage placement within the commercial yielding a query set run time.

26. An interactive incentive driven participatory system for providing incentives to viewers as recited by claim 25, wherein the time percentage placement of the query set run time ranges from about 1% to 100% start time based on the commercial length.

27. An interactive incentive driven participatory system for providing incentives to viewers as recited by claim 25, wherein a set answer time frame is provided that extends to a time period after the program is aired to encourage viewers to watch the commercial within the program during playback via DVD, or other digital or playback recording mediums.

28. An interactive incentive driven participatory system for providing incentives to viewers of an advertising commercial and employing a device having capability to receive and transmit messages and accept input via a user interface, the system comprising:
a at least one advertising or promotional message having message content;
b at least one query associated with the message content;
c at least one user account having viewer/user information data adapted to be entered therein;
d at least one answer prompt being associated with the query adapted to prompt the viewer to respond and enter an answer through the device;
e a central processing station or distributed processing stations for receiving, storing, correlating answers, and correlating market data of the viewer/user; and
f a central processor adapted to receive and process the viewer's answers into points/tickets and market data;
wherein the viewers are provided incentives based on the viewer points or tickets for correctly answering the query and viewership of the commercial is adapted to be increased.

29. A method for providing an interactive incentive driven participatory system for providing incentives to viewers using a machine readable program storage device tangibly embodying a set of computer-readable instructions executable by the machine to allow the machine to interface with a system for enabling interactive participation by viewers or listeners viewing or listening to an advertiser message, the machine having capability to receive and transmit messages, accept input via a user interface, and display messages on an electronic display, the comprising the steps of:
a selecting at least one advertising or promotional message;
b selecting at least one query having content from or being associated with the advertising or promotional message;
c presenting at least one answer prompt associated with the query adapted to prompt the viewers to respond and enter an answer through a device adapted to transmit and receive messages with the system;
d receiving and storing the answers of the viewers within a central processing station or distributed processing stations;
e computing viewers answers to extrapolate viewer points or tickets and market data;
wherein the viewers are provided incentives based on the viewer tickets for correctly answering the query and viewership of the commercial is adapted to be increased.
